(19) United States
(12) Patent Application Publication
(10) Pub. No.: US 2009/0219652 A1
(43) Pub. Date: Sep. 3, 2009

(54) Actuator for access to strorage media

(76) Inventors: Michael Bammert, Hardt (DE); Tsuneo Suzuki, Moenchweiler (DE); Rolf Dupper, Villingen-Schwenningen (DE)

Correspondence Address: Thomson Licensing LLC, P.O. Box 5312, Two Independence Way, PRINCETON, NJ, 08543-5312, US

(21) Appl. No.: 11/919,854

(22) PCT Filed: Apr. 10, 2006
(86) PCT No.: PCT/EP2006/061485

§ 371 Date: Jan. 22, 2009

(30) Foreign Application Priority Data
May 4, 2005 (EP) 05103771.1

(51) Int. Cl. G11B 7/00

(52) U.S. Cl. 360/245.9; G9B/7

(57) ABSTRACT

The invention relates to actuators on pickups for access to moving storage media. An actuator according to the invention comprises a circuit board which, in an edge region, has a metallization on its edge or metallizations adjacent to the edge on two or more inner or outer surfaces, suspension wires for connecting the actuator to a carrier being soldered onto these metallizations.

The invention relates to actuators on devices also known as pickups for access to moving storage media.

For the purpose of access to moving storage media, use is made of devices also known as pickups, which have a carrier and an actuator. In this case, access summarizes read access for reading information from the storage medium or write access for writing or recording information into the storage medium, or combinations of write and read access.

It is known to connect the actuators of pickups to the carrier by means of suspension wires. Here, carrier is intended to designate all of those subassemblies which are rigidly connected to one another and relative to which the actuator is moved. The suspension wires form a connection between the actuator and the carrier which, at the same time, can be mechanically elastic and electrically conductive. By means of a mechanically elastic connection, the actuator can be moved in specific directions provided for this purpose about a central position, experiences a restoring force in the direction of the central position and is generally guided largely rigidly in other directions. By means of an electrically conductive connection, currents for actuating the actuator can be conducted from drive electronics located on the carrier to coils located on the actuator. It may be expedient to express the properties of the mechanical elasticity and of the electrical conduction to an unequal extent by means of constructional measures in the individual suspension wires.

It is known to solder the suspension wires by their respective ends to the actuator and to the carrier in holes in printed circuit boards.

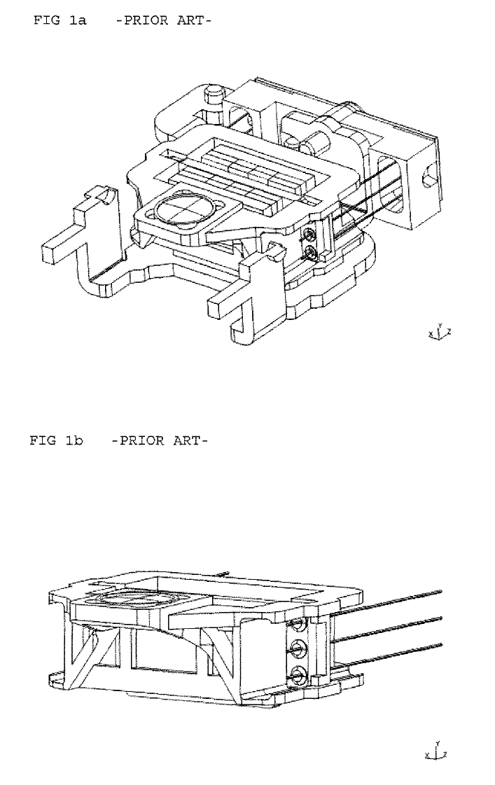

The following can be seen as disadvantageous when soldering the suspension wires into holes in printed circuit boards:
a suspension wire inserted into a hole in a circuit board and therefore surrounded by a circuit board on all sides needs a great deal of space, see FIGS. 1a, 1b, 1c;
holes must be produced, for example by means of drilling or punching, their production gives rise to costs and often loads or ages the surrounding material;
the insertion of the suspension wires into holes is a fabrication step which is complicated and requires close mechanical tolerances and which, under certain circumstances, limits the fabrication cycle time.

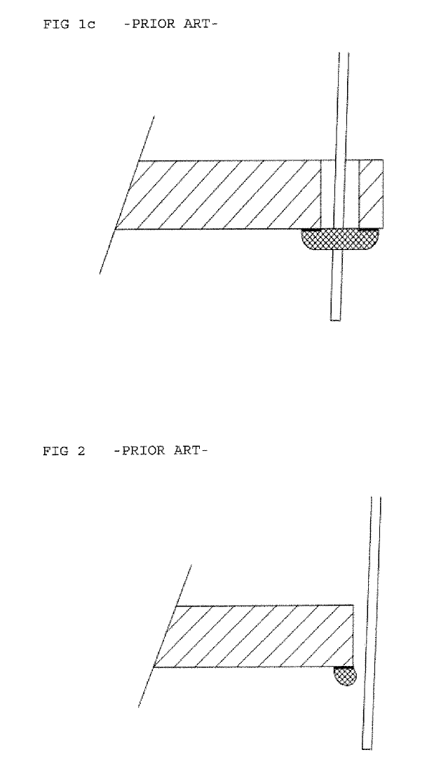

On a conductor track which, as shown in FIG. 2, is led only as far as the edge of a circuit board, a wire running at right angles to the surface of the circuit board cannot be soldered on or can be soldered on only unreliably because of the surface tension or the adhesion force of the solder on the conductor track.

It is an object of the invention to improve an actuator of the type described with regard to the aforementioned disadvantages in fixing the suspension wires.

According to the invention, a printed circuit board of an actuator has, in an edge region, at least two conductor tracks reaching as far as the edge in at least two outer or inner surfaces of the circuit board, and the suspension wires of the actuator are soldered onto these at least two conductor tracks in such a way that the solder is connected so as to bridge the two conductor tracks.

Likewise according to the invention, a printed circuit board of an actuator has, in an edge region, a metallization of its edge surface, produced by means of plating through, to which suspension wires are soldered. Optionally, in this case the soldering can additionally extend to adjacent conductor tracks on outer or inner surfaces of the circuit board.

A method according to the invention for producing a connection between an actuator and a carrier consists
in providing two or more conductor tracks in two or more layers of the circuit board in a region of the edge of a circuit board provided for soldering, and
in soldering suspension wires laterally to these conductor tracks in such a way that the solder is connected so as to bridge the two or more conductor tracks.

A method according to the invention for producing a connection between an actuator and a carrier consists
in producing a metallization by means of plating through in a region of the edge of a circuit board provided for soldering, and
in soldering suspension wires laterally to this metallization of the printed circuit board.

Irrespective of the embodiment of the soldering, in this case the printed circuit board is, for example, a circuit board which bears printed coils of the actuator directly, but can also be a circuit board to which, in addition to the suspension wires, connections of conventionally wound actuator coils are also connected.

Advantages of the invention are
saving space;
avoiding the necessity of producing through holes, for example by drilling or punching.

Further advantages of the invention and variants are specified in the following description of exemplary embodiments. Here,

FIG. 1a shows a pickup of the prior art with an actuator;

FIG. 1b shows the actuator of the pickup from FIG. 1a at a different viewing angle;

FIG. 1c shows a section through one of the soldering eyes according to FIG. 1a;

FIG. 2 shows a section through a soldered connection from the prior art with a circuit board edge bearing a conductor track on one side;

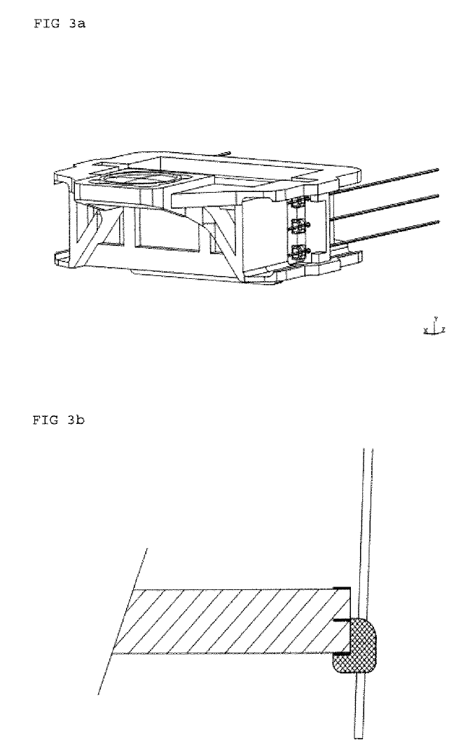

FIG. 3a shows a first embodiment of a pickup according to the invention;

FIG. 3b shows one of the soldered points according to FIG. 3a in section;

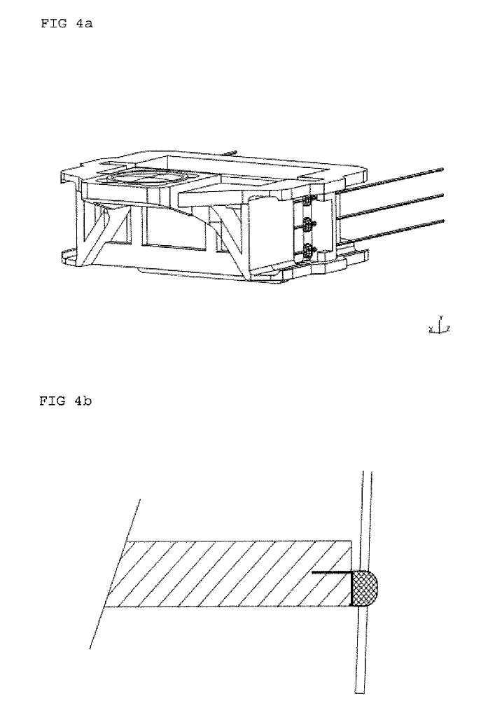

FIG. 4a shows a second embodiment of a pickup according to the invention;

FIG. 4b shows one of the soldered points according to FIG. 4a in section;

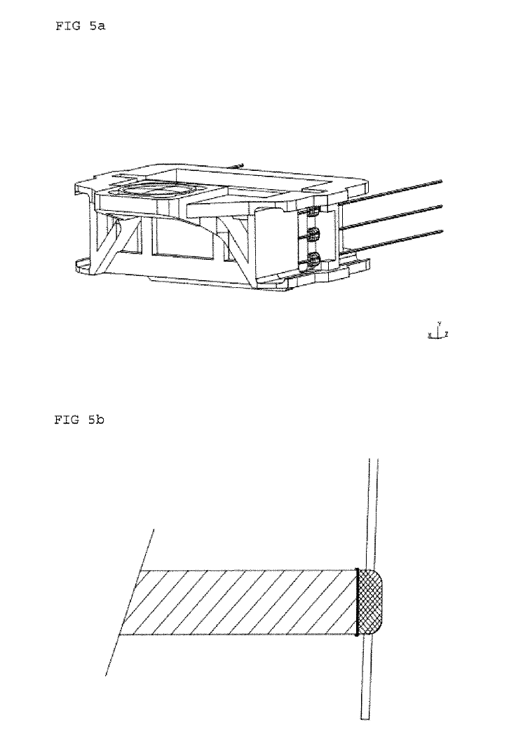

FIG. 5a shows a third embodiment of a pickup according to the invention;

FIG. 5b shows one of the soldered points according to FIG. 5a in section;

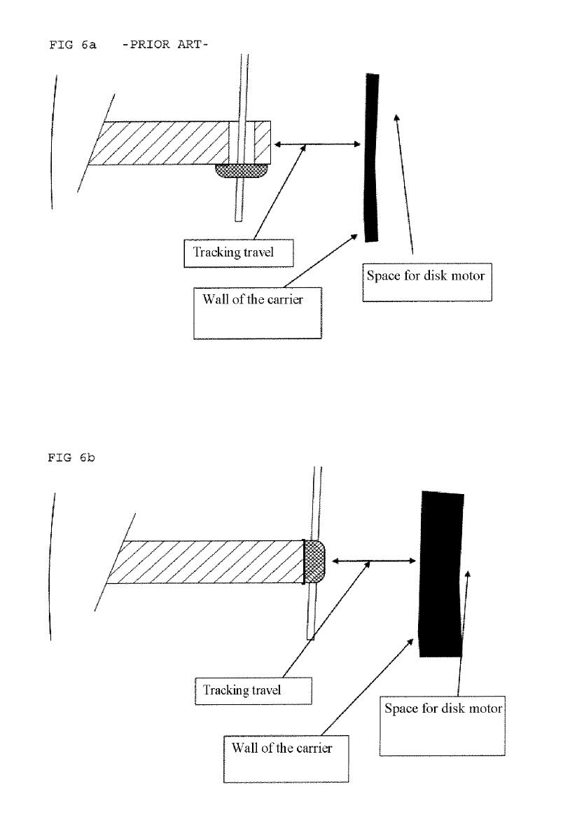

FIG. 6a shows the physical relationships in an actuator from the prior art;

FIG. 6b shows the physical relationships in an actuator according to the invention with the suspension wires soldered laterally to the circuit board.

FIG. 1a shows a pickup 1 from the prior art with an actuator 2 which, here, has a single printed circuit board 3 which is guided approximately centrally between the magnets 4, 5 fixed to the carrier. Of the total of six suspension wires 6 with which the actuator 2 is connected to the carrier 7, three are largely completely visible in the right-hand part of FIG. 1a; of the remaining three suspension wires 6, only two can be seen in small sections in the left-hand part of the figure, because their remainder is hidden behind the actuator 2. Two of the soldering eyes 8, with which the suspension wires 6 are soldered in holes in the printed circuit board 3 in a manner known previously, are visible.

FIG. 1b shows the actuator from FIG. 1a at a different viewing angle.

FIG. 1c shows a section through one of the soldering eyes 8 according to FIG. 1a. The suspension wire 6, which is shown as perpendicular, passes through a hole 9 in the circuit board 3 and is soldered to a conductor track 10 surrounding the edge of the hole circumferentially. For the purpose of illustration in FIG. 1c, the hole 9 is drawn as exaggeratedly larger than the diameter of the suspension wire 6. In actual fact, the diameters of the hole 9 and of the suspension wire 6 are typically more similar. The suspension wire 6 is surrounded by solder 11 and by circuit board 3 on all sides. The solder 11 in the sectional illustration stretches over the conductor track 10 on the left-hand side of the hole 9, a central region fused to the suspension wire 6, and the conductor track 10 on the right-hand side of the hole 9, so that, despite the surface tension of the solder 11, reliable soldering is achieved.

FIG. 2 shows the comparable relationships if, instead of a hole 9 surrounded circumferentially with a conductor track 10, only one edge 12 of the circuit board 3 has a conductor track 13 on one side. As a result of the surface tension or adhesion of the solder 11 to the conductor track 13, the solder 11 has a great tendency to form a convex soldering eye 14 over the conductor track 13, so that fusing of the solder 11 to the suspension wire 6 placed beside it does not take place at all or not reliably.

Depending on other requirements on the pickup, the making of plated-through contact according to the invention of the circuit board or the layers of a circuit board which, under certain circumstances, may be designed in many layers, can be varied individually. For instance, it is conceivable that a plated-through contact or metallization soldered to the suspension wire connects a first surface of the circuit board, for example the upper outer surface, and a second surface of the circuit board, for example the lower outer surface, while one or more surfaces assumed to be located between these, for example inner surfaces of a circuit board assumed to be multi-layered, are not connected electrically to the metallization.

FIGS. 3a, 3b, 4a, 4b, 5a, 5b show devices according to the invention having a different extent of the metallization or the plated-through contact. A plated-through contact area extending laterally, that is to say over the thickness of the circuit board, if present, is used for soldering in all the forms.

FIGS. 3a and 3b reveal that, according to the invention, it is also possible to use only conductor tracks 15, 16 on the outer or inner surfaces of a circuit board 3 of multilayer design for soldering. In this case, contact can be made more variably. The soldering is shown only on the conductor tracks 15, 16 or copper layers going as far as the edge. These are typically the coil connections of printed actuator coils, not shown here, but can also be conductor tracks which lead to the connections of wound actuator coils. The construction shown in FIGS. 3a, 3b has no plated-through contacting. The soldering is reliable, since the solder 11 can reach over a first conductor track 15, a central region fused to the suspension wire 6 and a second conductor track 16.

Actuators 2 according to the invention can be used for pickups 1 having very small dimensions. As a result of the type of soldering according to the invention, space at the sides can be saved, since the suspension wires 6 are no longer surrounded by solder 11 and circuit board 3 on all sides of the soldered point 8. This space saved can be used, firstly, to keep the dimension of the actuator 2 and therefore, if advantageous, also the dimensions of the entire pickup 1 surrounding the actuator 2 small. Alternatively, the space saved can be used for reinforcements of the lens holder 17 or the carrier 7, for example by additional walls or reinforcing ribs being provided. In addition, in the case of soldering according to the invention, plated-through holes 9 can be dispensed with, which results in a saving in costs during production and possibly also during mounting and fabrication.

FIG. 3a shows one embodiment of an actuator 2 according to the invention. Three of the suspension wires 6 are soldered laterally onto the circuit board 3 at the three visible soldering points 8.

FIG. 3b shows one of the soldering points 8 according to FIG. 3a in section. Here, the solder 11 reaches over a first conductor track 15 on the underside of the circuit board 3, the region fused to the suspension wire 6 and a second conductor track 16, here assumed to be in the centre of the circuit board 3.

FIG. 4a shows a second embodiment of an actuator according to the invention; FIG. 4b shows one of the soldering points 8 according to FIG. 4a in section. The solder 11 here connects a metallization 18 of the side edge 12 of the circuit board 3, produced by means of plated-through contact, over part of its depth and the suspension wire 6.

FIG. 5a shows a third embodiment of a pickup according to the invention; FIG. 5b shows one of the soldering points 8 according to FIG. 5a in section. Here, the solder 11 connects a metallization 18 of the side edge 12 of the circuit board 3, produced by means of a plated-through contact, over its entire depth to the suspension wire 6.

FIG. 6a shows the physical relationships when a suspension wire 6 according to the prior art is soldered in a hole 9 of a circuit board 3 of an actuator 2, and, in the process, sufficient space in relation to an adjacent wall 19 of a carrier 7 carrying the actuator must remain in order to permit the actuator an at least necessary tracking travel 20, that is to say a minimum deflection, in the tracking direction. The position of the wall 19 is in this case given by there having to be space 21 for a disk motor behind the wall 19.

FIG. 6b shows the comparable physical relationships when a suspension wire 6 is soldered laterally according to the invention to the edge 12 of a circuit board 3 of an actuator 2. Here, too, it is assumed that a space according to a minimum required tracking travel 20 of the actuator 2 must be maintained as far as the adjacent wall 22 of the carrier 7. It is indicated in the figure that the smaller space required by the soldering according to the invention can be used, inter alia, to choose the wall 22 to be thicker than the wall 19 possible according to the prior art.

1. An actuator in a pickup for access to moving storage media, comprising a circuit board, a carrier and suspension wires for connecting the actuator to the carrier wherein the circuit board has a metallization on one of its edges, and the suspension wires are soldered onto this metallization.

2. The actuator according to claim 1, in which the circuit board has outer or inner surfaces carrying conductor tracks, and the soldering of the suspension wires to the metallization additionally extends to adjacent ones of the conductor tracks.

3. An actuator in a pickup for access to moving storage media, comprising a circuit board (3) having edges and outer or inner surfaces, the pickup having a carrier and suspension wires for connecting the actuator to the carrier, wherein, adjacent to one of its edges, the circuit board has two or more metallizations of its surfaces, and the suspension wires are soldered onto the metallizations.

4. A pickup for access to moving storage media, having an actuator according to claim 1.
